(19) United States
(12) Patent Application Publication
(10) Pub. No.: US 2016/0374488 A1
(43) Pub. Date: Dec. 29, 2016

(54) OVERMOLDED LOW COST CUTLERY

(71) Applicant: MODERN PACKAGING LLC, Chicago, IL (US)

(72) Inventors: Benjamin SHAPIRO, Chicago, IL (US); Christopher WLEZIEN, Chicago, IL (US); Martin RATHGEBER, Chicago, IL (US); Matthew SHAPIRO, Chicago, IL (US)

(21) Appl. No.: 15/186,388

(22) Filed: Jun. 17, 2016

Related U.S. Application Data
(60) Provisional application No. 62/185,330, filed on Jun. 26, 2015.

(51) Int. Cl. A47G 21/02; B29C 45/16; B29C 45/02; B26B 3/02; A47G 21/04

(52) U.S. Cl. CPC A47G 21/023; B26B 3/02; A47G 21/04; B29C 45/02; B29C 45/16; B29K 2021/00

(57) ABSTRACT

The invention relates to a molded article that includes a first molded structure that includes a working end, a bottom end, at least one wall member extending from the working end to the bottom end of the structure and at least partially or fully outlining a handle for the article, at least one decorative feature that resides on the handle surface of the article, and a connecting element that provides a flow path for first material to fill the decorative feature(s). The first molded structure is configured and dimensioned to receive a second material that also resides on the handle surface surrounding the decorative feature(s). The second shot molded structure is molded from the second material and includes surface portions that form top and bottom surfaces of the handle and that surround or encompass but do not cover the decorative feature(s) of the first molded structure.

The application claims the benefit of U.S. application No. 62/185,330 filed Jun. 26, 2015, the entire content of which is expressly incorporated herein by reference thereto.

### BACKGROUND

The invention relates to articles that include design features that facilitate rapid production when utilizing a two-shot overmolding process to produce low-cost articles such as disposable cutlery.

It is generally known to use a two-shot molding process to manufacture articles having different colors or different features. For example, US patent publications 2011/0219631 and 2013/0047528 and U.S. Pat. Nos. 5,049,343, 7,487,007, 7,811,497, 8,012,398, 8,414,813 and 8,747,100 disclose various molding production techniques. In short, these known, general state-of-the-art processes have considerable drawbacks in that specific, numerous, and therefore costly or oversized tools, must be used, requiring relatively long cycle times and often creating insufficient and imperfect quality pieces. Thus, as can be seen, the existing techniques do not meet the need that exists for so-called “aesthetic” pieces such as those currently needed for the preparation of smaller articles such as utensils.

Therefore, a need exists to provide a simplified and easily-adapted process to enable making multi-material, locally overmolded pieces (or elements of pieces), particularly those consisting of different color or material, which can be made at high production rates with a very high level of quality, particularly as regards the finish and aesthetic appearance of the final product. Accordingly and in particular, there is a need for improved designs of inexpensive articles such as disposable cutlery to facilitate the efficient and effective manufacture of such products. The present invention now addresses this need.

### SUMMARY OF THE INVENTION

The invention relates to a molded article comprising a first shot molded structure that includes a working end, a bottom end, at least one wall member extending from the working end to the bottom end of the structure and at least partially or fully outlining a handle for the article, at least one decorative feature that is configured and dimensioned to reside on a surface of a handle of the molded article with the decorative feature(s) spaced from and residing between the wall member(s), and a connecting element that facilitates a flow path for first shot material to fill the decorative feature(s). The first shot molded structure is configured and dimensioned to receive a second material that resides on the handle surface surrounding the decorative feature(s).

Advantageously, the decorative feature(s) have a continuous or discontinuous configuration and can be provided as a single or multiple decorative features. Typically, each decorative feature resides at least partially or fully on the handle surface and may be associated with a separate connecting element. For convenience, in some embodiments, multiple decorative features are associated with a single connecting element.

Generally, some, most or even all of the decorative features reside between the wall member(s). In a preferred embodiment, the wall member is a single wall member that is configured and dimensioned to outline the handle of the article as an outer sidewall. In this embodiment, the connecting element may be a rib that connects the first decorative feature(s) to the sidewall. Also, the connecting element includes an elongated rib member that includes a protruding portion along at least a portion or all of its length, with the elongated rib member generally being at least as wide as or wider than the protruding portion.

In another embodiment, first and second wall members are provided as an outline of an upper portion of the handle and the wall members terminate in an angled side configuration which provides a shutoff for the second shot material. And another arrangement includes having the first molded structure configured with one or more holes or openings therethrough to allow the second material to form parts of the front and rear surfaces of the article.

The article is advantageously configured to provide an injection port that is received adjacent a portion of the first molded structure which is to be overmolded by the second material so that the first injection port does not leave a visible mark on the final overmolded article.

It is desirable for the molded structure to be designed with specific draft angles. In particular, when the molded structure has a core mold side and a cavity mold side, the portions of the first molded structure that reside in the core mold should have draft angles of less than 2 degrees and as low as 0.25 degrees, while the portions of the first molded structure that are on the cavity mold side should have draft angles that are greater than 2 degrees and as much as 5 degrees or more.

The article further comprises a second shot molded structure molded from the second material and including surface portions that form top and bottom surfaces of the handle and that surround or encompass but do not cover the decorative feature(s) of the first molded structure.

The preferred wall member is a single sidewall that is configured and dimensioned to outline the handle of the article and the sidewall fully surrounds or encompasses the second shot molded structure. The connecting element includes the elongated rib member described herein that includes a protrusion portion to prevent lateral movement of the first molded structure when the second material is introduced onto the first molded structure.

Various types of decorative elements can be provided. One preferred decorative feature of the first molded structure is a teardrop shaped element that is present on a front surface of the handle with the connecting element forming a further decorative feature on a rear surface of the handle. Further decorative feature(s) include one or more cylindrical elements which extend to a front surface of the handle. These decorative feature(s) may include one or more linear elements which are continuous or discontinuous and which reside on a front surface of the handle, a rear surface of the handle, or on both surfaces with the linear element(s) associated with a single connecting element or each linear element connected to a separate connecting element. Additionally, the decorative elements may include one or more protruding members that protrude from the handle surface at, along or about its periphery.

Another embodiment of the invention relates to a molded article comprising a first shot molded structure comprising a working end, a bottom end, at least one wall member extending from the working end to the bottom end of the structure and at least partially or fully outlining a handle for the article; wherein the molded structure has a core mold side and a cavity mold side. Portions of the first molded structure that reside in the core mold have draft angles of less than 2 degrees and as low as 0.25 degrees so that that side of the structure is secured in the mold to resist movement or dislodgement when the outer mold cavity is changed from one that molds the first shot molded structure to one that is used to mold the second shot molded structure. Also, portions of the first molded structure that are on the cavity mold side have draft angles that are greater than 2 degrees and as much as 5 degrees or more so that they release easily from the outer mold cavity that molds the first shot molded structure when it moves away to allow the outer mold cavity for formation of the second mold structure to be placed thereover.

Advantageously, the first shot molded structure is configured and dimensioned to receive a second material that at least partially resides on the handle surface.

It is also possible for the first shot molded structure to include plurality of elongated members, ribs or bands extending away from the working end. If desired, these elongated members, ribs or bands may include a protrusion portion that prevents lateral movement of the first molded structure when the second material is introduced onto the first molded structure.

Another arrangement is one where the wall member of the first shot molded structure is a single wall member that is configured and dimensioned to outline the handle of the article as a sidewall.

The article preferably comprises a second shot molded structure molded from the second material and including surface portions that form at least part of the top and bottom surfaces of the handle.

When the first shot molded structure further comprises a plurality of elongated members, ribs or bands extending away from the working end, the second shot molded structure will include a plurality of elongated members, ribs or bands that are located adjacent the elongated members, ribs or bands of the first shot molded structure to form the handle of the article.

When the wall member of the first shot molded structure is a single wall member that is configured and dimensioned to outline the handle of the article as a sidewall, all of the second shot molded structure will reside within the sidewall.

For these articles, the first and second molded structures are made of a plastic resin, an elastomer, or a polyurethane material, and the first material contrasts with the second material by color, transparency, translucency, brightness, texture, hardness or another physical property. Also, the preferred articles are in the form of cutlery wherein the working end is a fork, knife or spoon.

### BRIEF DESCRIPTION OF THE DRAWINGS

Preferred features of the invention will now be described in connection with the appended drawings, wherein:

FIG. 1 is a front view of an overmolded article in accordance with the invention, specifically in the form of a fork that represents the preferred embodiment of a cutlery item;

FIG. 2 is a sectional view of an upper portion of the handle of the fork of FIG. 1 taken along lines A-A of FIG. 1;

FIG. 3 is a sectional view of a mid-portion of the handle of the fork of FIG. 1 taken along lines B-B of FIG. 1;

FIG. 4 is a sectional view of a lower portion of the handle of the fork of FIG. 1 taken along lines C-C of FIG. 1;

FIG. 5 is a rear view of the fork of FIG. 1;

FIG. 6 is a side view of the fork of FIG. 1;

FIG. 7 is a front view of another overmolded fork in accordance with a further preferred embodiment of the invention;

FIG. 8 is a sectional view of an upper portion of the handle of the fork of FIG. 7 taken along lines D-D of FIG. 7;

FIG. 9 is a sectional view of the lower portion of the handle of the fork of FIG. 7 taken along lines E-E of FIG. 7;

FIG. 10 is a rear view of the fork of FIG. 7;

FIG. 11 is a side view of the fork of FIG. 7;

FIG. 12 is an enlarged front view of the first molded structure of the handle of FIG. 1;

FIG. 13 is an enlarged rear view of the first molded structure of the handle of FIG. 1;

FIG. 14 is an enlarged front view of the first molded structure of the handle of FIG. 7;

FIG. 15 is an enlarged rear view of the first molded structure of the handle of FIG. 7;

FIG. 16 is a front view of another overmolded fork in accordance with another preferred embodiment of the invention;

FIG. 17 is a rear view of the fork of FIG. 16;

FIG. 18 is a front view of another overmolded fork in accordance with yet another preferred embodiment of the invention;

FIG. 19 is a rear view of the fork of FIG. 18;

FIG. 20 is a side view of the fork of FIG. 16;

FIG. 21 is a side view of the fork of FIG. 18;

FIG. 22 is a sectional view of an upper portion of the handle of the fork of FIG. 16 taken along lines F-F of FIG. 16;

FIG. 23 is a sectional view of a lower portion of the handle of the fork of FIG. 16 taken along lines G-G of FIG. 16;

FIG. 24 is a sectional view of an upper portion of the handle of the fork of FIG. 18 taken along lines H-H of FIG. 18;

FIG. 25 is a sectional view of a lower portion of the handle of the fork of FIG. 18 taken along lines I-I of FIG. 18; and

FIG. 26 is a partial view of the front surface of a mold form for making multiple molded articles according to the invention.

### DETAILED DESCRIPTION OF THE INVENTION

The present invention is preferably directed to plastic cutlery and a molding method for making such cutlery. The term “cutlery” is used herein to refer to eating utensils such as knives, spoons, forks, salad forks, soup spoons, butter knives, steak knives, cocktail forks, serving forks and spoons, tongs, chop sticks, cake cutters, spatulas, ladles, food picks, kitchen utensils, and the like, all of which are characterized by a handle and a working part joined to the handle to form a tool. The handle is the part grasped by the user. The term “working part” in the present context of cutlery is the part opposite and joined to the handle of the cutlery that is configured to be used in the processes of holding, cutting, manipulating, serving, consuming or conveying food and that comes into contact with food in process and/or into contact with the mouth of the user.

As used herein, the term “plastic” means a material that may be fixed in a desired shape by molding. The plastic may be a resin and in particular a synthetic resin either based on petrochemicals or other biological materials such as cellulose, soybeans or agricultural by-products, all of which are often polymerized on cooling and may thus be formed in the desired shape by using injection-molding from resin particles or beads. The shaped plastic must be sufficiently rigid for use as cutlery and tableware and may derive its strength inherently, or when augmented by the configuration into which it is molded, that is, with ribs and beads for stiffening of hollowed areas, or by the use of reinforcing fibers. The plastic must also be capable of pigmentation in a variety of colors, texturization, and be non-toxic and able to incorporate additives. The plastic is also ideally inexpensive and readily available in large quantities. It also includes materials having an elastomeric nature that can be injection molded. Additionally, other injection moldable materials such as elastomers, polyurethanes may be used in essentially the same manner as the plastic materials described herein.

In the following, the various molded plastic articles of the invention will be preferably illustrated as cutlery although as noted herein other molded articles can be made by the present invention.

The articles of the invention are conveniently made by conventional overmolding process wherein a second material is molded over a first molded structure to make the article. The mold parts can be easily designed and configured to produce the desired first and second shots with the complete or nearly complete avoidance of parting lines, bleeding of the second material onto the first shot where not desired, and with designs that facilitate material flow and complete filling of all openings of the mold cavities without generating unfilled areas or air voids therein.

In the description that follows, the term “first shot” will be used to define the first molded structure that is obtained by molding a first resin, while the term “second shot” will be used to define the second molded structure that is overmolded on the first shot to form the final article. The preferred cutlery articles of the invention are represented by a fork. Of course, it is easily envisioned that a spoon or knife can similarly be provided, as can other cutlery or similar sized disposable articles such as toothbrushes, razors and the like. As the overmolding process is generally known, there is no need to further describe it herein. Furthermore, the present articles are designed with features in the first shot that facilitate and enhance the production of the second shot.

The molds provides different cavities that are configured to form the second shot in the open volume between the mold and the surface of the first shot, with the second shot not extending over the entire surface of the first shot. Thus, the injection of the second material forms the second shot that covers only a portion but not all of the surface of the first shot. In some embodiments, the second shot resides completely within the first shot, while in other embodiments, the first and second shots are adjacent to form alternating portions of the final molded article. Advantageously, the second material is different from the first material in type of material, color, texture, hardness or other physical property. Also, the first and second materials are typically of a plastic, an elastomer or polyurethane material. The first material is injected to a mold having a first configuration and is allowed to set to form the first molded structure. Next a further mold configuration which conforms to the final shape of the article is provided around the first molded structure and the second shot material is injected. Typically, the mold containing the first molded structure is rotated from the first station where the first molded structure is made to a second station where further mold portions are positioned around the first molded structure to form the second molded structure. After the injection of the second material is complete and the final dual shot article is formed, the second material is allowed to set into the final shape before removing the article from the mold.

In order to facilitate the overmolding of the second shot onto the first shot, the interface surfaces on the back side of the cutlery that reside in the initial mold should preferably have a minimal draft angle. Generally, the draft angle for these interface surfaces will be less than 2 degrees and typically as low as 0.25 degrees. This is in contrast to front sidewalls or other shapes of the first shot molded structure that are exposed when the mold on the cavity side is removed and replaced by a further mold. To improve the removal of the mold after formation of the first molded structure, these shapes are provided with draft angles that are greater than 2 degrees and are typically between 3 to 5 degrees. A greater angle can be better in some designs, but 3 to 5 degrees have been found to be sufficient for most moldings of the types disclosed herein for creating the molded articles of the present invention.

It is useful to have completely vertical walls or sides for the upper portions of the first mold structure to receive the second mold for the second molded structure. These interface surfaces typically include the top portions of the sides of the decorative features on the handle. Providing these surfaces with higher draft angles to facilitate withdrawal of the first mold before the second shot is injected and minimizes sticking of the second shot to the second mold cavities after molding.

The combinations of these first and second shot molded structures and draft angles for the walls and design features facilitate the efficient manufacture of the articles both as to the provision of higher cavitation tooling. This is also an optimal design for allowing the first molds to move in and out when reconfiguring to change from the first shot cavity to the second shot cavity. This also reduces the maintenance required on the molds.

The first or second material to be injected is preferably a plastic resin, an elastomer, or a polyurethane material and is used to form the first and second shots. As noted, one material contrasts the other by color, transparency, translucency, brightness, texture, hardness or another physical property. The injection of such materials is also improved in that the number of injection ports is reduced due to the provisions of the holes or open structures in the first molded structure that allow the injected second shot material to flow from one side of the first shot molded structure to the other side.

Various visual effects can be provided on the handle by the provided thickness of the second shot. For the portions that are provided upon the first shot, providing a uniform thickness of the second shot would result in a uniform color and optical appearance of that structure. Enhanced visual effects can also be created by varying the thickness of the second shot to create color nuances. For example, when the first shot structure is a color other than white (such as blue, red, green, black, etc.) and the second shot is clear or translucent, thicker layers of the second shot will generally result in a dulling or lessening of the perceived color of the first shot while thinner layers of the second shot would allow more of the color of the first shot to be observed. Also, when the first shot molded structure is opaque white and the second shot is a transparent different color (such as blue, red, green etc.), thicker layers of the second shot will generally result in darker or deeper final colors while thinner layers will be lighter.

For color contrast, the first shot may be molded from a material that is transparent or has a color, while the second shot is molded from a material having a different color that contrasts with the color of the first molded structure or vice versa. Also, one of the shots can be transparent or translucent with or without a color. The second shot is generally provided upon both the front and back of the handle as shown herein. Thus, a skilled artisan can create many different types of designs and color combinations for both the front and rear sides of the molded articles of the invention.

In order to manufacture disposable articles such as cutlery and the like, certain elements have been designed into the structure of the cutlery that would not normally be used or required. These include (i) a discontinuous first molded structure that includes ribs that provide a path for flow of the introduced or injected first material to fill the various ornamentation features, outline and working end of the first shot; (ii) a protrusion from or lower extension of the ribs that secures the first molded structure in the mold to resist lateral movement as the second shot material is introduced or injected; (iii) flow through holes or portions of the first molded structure that are open to allow the second shot material to flow through to provide a second molded structure that includes shaped features in upper and lower surfaces of the final molded article; (iv) a first shot material injection point located on a connecting rib so that it is not visible in the final article due to the overmolding of the second shot material; (v) an angled side shutoff for the second shot material; (vi) a second shot injection site that is placed on a decorative feature so that it appears to be part of the feature rather than an injection site mark; and (vii) for certain embodiments, the provision of a sidewall that extends above and about the perimeter of the elongated handle in order to provide a border within which is received the second shot material so that the second molded structure is located completely within the border.

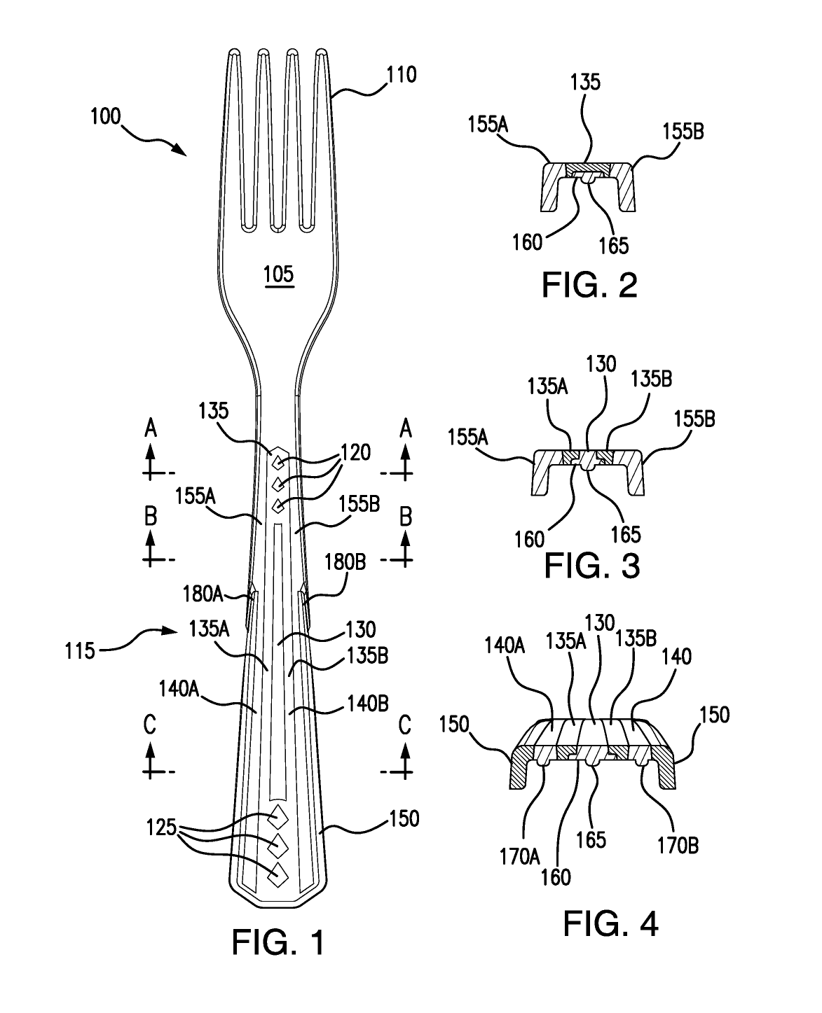

Turning now to the drawings, FIG. 1 illustrates an overmolded fork 100 according to the present invention. Fork 100 includes working end 105 with tines 110 and a handle portion 115. The front or top of the fork includes a pattern that includes decorative features such as diamonds 120 on and upper portion of the handle, diamonds 125 on a lower portion of the handle, and intermediate elongated bands 135A, 135B, 140A, 140B, of different colors. Bands 135A, 135B join each other at their upper ends to form an area 135 which surrounds diamonds 120. Also included is a handle border 150 which is provided on a lower portion of the handle. Diamonds 120, 125 are spaced from and reside between elongated bands 140A, 140B which form wall members of the first molded structure.

Diamonds 120, 125 and bands 130, 140A, 140B are of one color and match the color of working end 105 and side upper handle portions 155A, 155B as all of these are components of the first molded structure. Some of the bands, e.g., 135A, 135B, and the border 150 are also of the same color as they are components of the second molded structure which is overmolded onto the first molded structure. The contrasting color effect of the multiple linear arrangements is easily achieved by splitting the wall thickness into thinner layers in the first and second molded structures. The bands may also be as long or short as needed to convey the desired decorative features of the handle surface.

The resulting molded article is thus provided with a number of decorative features regarding the arrangement of the diamonds and bands. The design may vary on the top and bottom of the article part with circles, rectangles, stars or other shapes instead of the diamonds and/or with other continuous or discontinuous or isolated shapes in place of the bands which are shown in the preferred embodiment as elongated expanding rectangles or trapezoids. The same is true for the shapes of the elongated ribs and stabilizing protrusion portions on the bottom of the first molded structure except that these are typically continuous so that first material can be delivered to fill those features on the first structure. The protrusion portions are configured for stabilizing the first molded structure in the mold when the second material is injected.

FIGS. 2 to 4 illustrate the positions and arrangement of the various decorative features along the length of the handle. Beneath the diamonds 120, band 130 and diamonds 125 is a common elongated rib 160 which extends to the injection point and directs the injected first material into those features. For this purpose rib 160 can be relatively thin or of minimal thickness. Rib 160 may be continuous and of variable width which is shown as having a widened lower portion. Rib 160 includes a lower protruding portion 165 which is formed from a mold cavity when the first material is injected to form the first molded structure. Rib 160 and protruding portion 165 perform two functions. A first function is to act as a stabilizing member to help provide lateral stability to the first molded structure when the second material is introduced or injected into the mold to form the second molded structure. This enables the first molded structure to be retained in its desired position so that the final molded structure is more uniformly formed. It also avoids movement of the rib 160 which could interfere with or block the injection of the second material which would then result in discontinuities or incomplete formation of the second molded structure and final overmolded article. Additionally, rib 160 and protruding portion 165 may be configured in certain embodiments as reinforcements that provide strengthening of that portion of the handle where they are located when the article is used.

FIG. 3 illustrates the arrangement of bands 135A, 135B which are adjacent rib 160, while FIG. 4 illustrates the arrangement of bands 140A, 140B and border 150. Similar to band 135, bands 140A, 140B include protruding portions 170A, 170B which cooperate with bands 140A, 140B to perform additional stabilizing of the first molded structure during injection of the second material as well as some additional strengthening of the handle when the article is used.

An alternative way to provide stabilization for the first shot structure would be to simply make the entire width of the bands of the first shot protrude beyond the bottom of the handle and into the mold to provide the desired stabilization of the first mold structure when the second shot is introduced.

The protruding portions of the bands are shown as having a cross-section of approximately a half circle. If desired, however, the shape of the protruding portions can be polygonal or in particular rectangular or square. For the shapes each sidewall of the protruding portions would be configured with ideal draft angles of between about ½ to 2 degrees.

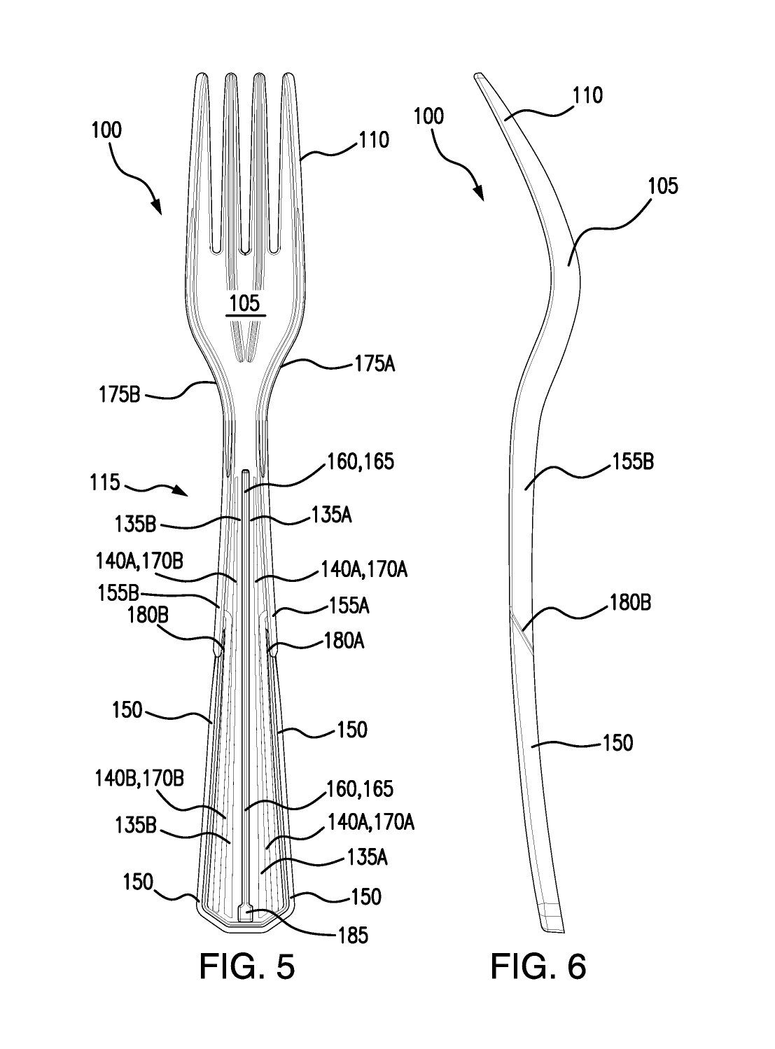

FIGS. 5 and 6 illustrate the rear and side views of the fork 100 of FIG. 1 wherein the same numerals are used to designate the same components described previously. In addition, another feature is shown that facilitates the overmolding of the second shot. For this purpose, an angled shut off 180A, 180B is provided so that the first molded structure easily accommodates the second material to form the second molded structure. This ensures good shut off from the second shot cavity onto the molded first shot structure and reduces skinning or flashing of the second shot material when overmolded onto the first molded structure. The angled shut off 180A, 180B is positioned at the overlap of the second molded structure on the handle 115 onto the first molded structure on the handle. This is provided by spacing the second shot to be within the width of the first shot so that the second shot can be shut off by the second mold contacting the first molded structure at that point. The width of the angled shutoff of the first molded structure which is not overmolded by the second material should be maintained at a minimum distance so that a sharp transition is not presented at that location in the final article. Another way to avoid a sharp edge or shoulder at that location would be to provide a softer material for the first shot molded structure rather one that is rigid. Also, surfaces 180A, 180B should be contoured for best results in shutoff and avoidance of a sharp transition.

FIG. 5 also illustrates a widened portion 185 of rib 260 which acts as a small reservoir when the plastic material is injected. It is preferably located beneath the injection point for the introduction of the first material that forms the first molded structure.

In FIG. 6, the protruding portions 165, 170A, 170B are not visible because they are smaller than the side upper handle portions 155A, 155B and border 150.

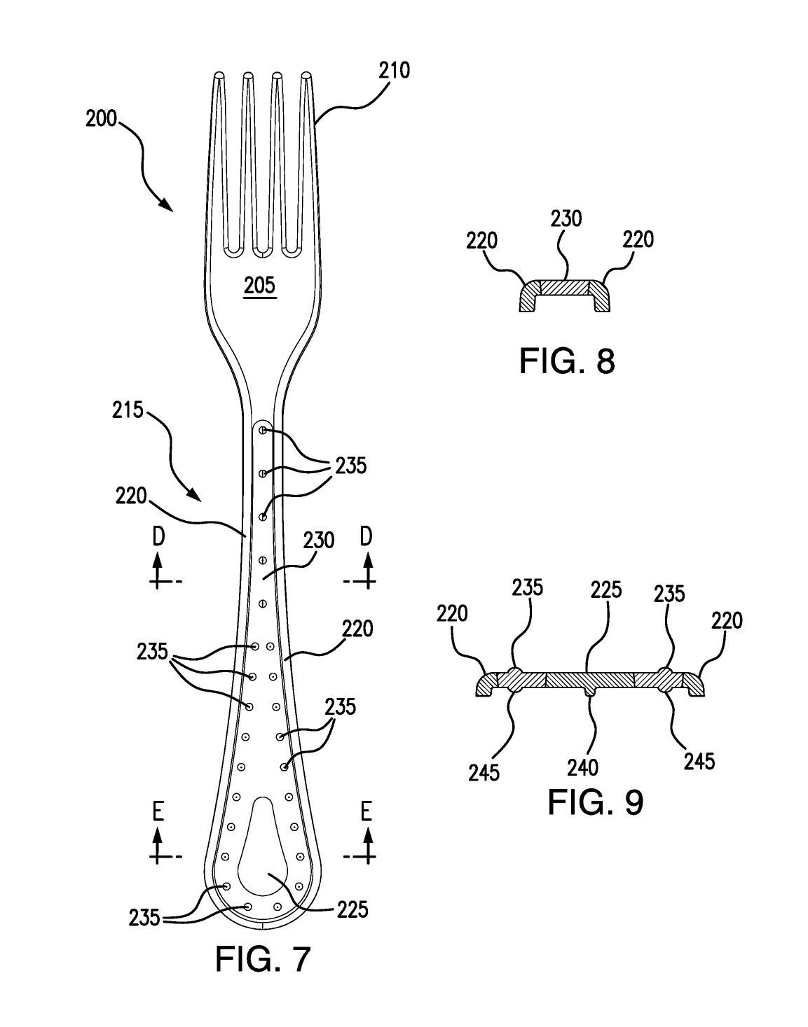

FIGS. 7 to 14 illustrate a second embodiment of the invention. These drawings illustrate an overmolded fork 200 that includes working end 205, tines 210 and a handle portion 215. The front or top of the fork 200 includes a pattern that includes decorative features including a wall member that forms a sidewall 220 that outlines the handle 215. A further decorative feature in the form of a teardrop shaped insert 225 is provided. These decorative features 220, 225 are part of the first molded structure and are made of the same first material. The first molded structure also includes the working end 205 of the fork 200 and the tines 210.

The second molded structure that is overmolded onto the first molded structure is a larger elongated insert 230 which surrounds the teardrop shaped insert 225 and which extends towards the working end of the handle. The elongated insert 230 includes as a decoration a number of raised bumps 235 which are positioned along the periphery or within insert 230. These provide a visual and tactile decorative feature for the fork 200. The bumps 235 and insert 230 are made of the same second shot material that forms the second molded structure.

As shown, the second shot material and molded structure is completely contained within the sidewall of the first molded structure. This allows for ideal material shut off and therefore a very low risk of the second shot material skinning or flashing over the first shot molded structure. In this regard, the sidewall acts as a shutoff for the injected second material and advantageously maintains the second material in the desired position, preventing it from bleeding onto the sidewalls of the first shot or from flowing onto the sidewall of the first molded structure.

Additionally, the sidewall of the first molded structure may be configured with a sufficient height that matches that of the proposed second shot in order to further prevent the aforementioned skinning and bleeding of the second material. This feature is further afforded by the fact that the sidewalls are built in such a way that they are flat on the top and bottom adjacent to the intersection of the first and second shot although they can be curved or rounded at the corners between the sides and tops or bottoms. In contrast, if the sidewalls had been manufactured with completely curved or rounded tops and bottoms, an unwanted skinning or bleeding across the first shot would occur. Having the sidewalls stick up from the top surface of the first shot along the sides of the handle provides a shut off that is perpendicular to the tool open/shut direction, whereas if they did not stick up and have a flat landing on top, bleeding or skinning would be expected around the edges of the first shot by the second shot. During the second shot, as noted, the second molding material can fill the front and rear of the handle from the injection site.

Another feature of the fork 200 of FIG. 7 is that it includes areas of high and low draft to improve demolding of the final article after the second shot material is overmolded onto the first molded structure. For this improvement, the areas on the core side of the fork 200 are drafted with minimal angles (such as 2 degrees or less) while the cavity side features are drafted to larger angles of between 2 and 5 degrees. The minimal draft on the core side ensures that the fork is retained in the core when the cavity is swapped between the molding of the first and second shots, while the larger draft angle on the cavity side of the first shot tool ensures that the mold(s) can be removed without the cutlery sticking to the mold which thus facilitates the reconfiguration of the mold for forming the second shot.

FIGS. 8 and 9 illustrate the positions and arrangement of the various decorative features along the length of the handle. Beneath the teardrop shaped insert 225 is an elongated protruding portion 240 which is used to direct the injected first material into the insert 225. This protruding portion 240 is formed from a lower cavity in the mold when the first material is injected to form the first molded structure. Protruding portion 240 also extends along rib 250 which is connected to the sidewall and which provides a flow path from the sidewall 220 to insert 225 when the first material in injected into the mold. Protruding portion 240 performs the same two functions described above, namely, to act as a stabilizing member to prevent movement of and provide lateral stability to the first molded structure when the second material is introduced or injected into the mold to form the second molded structure. This enables the first molded structure and in particular the teardrop shaped insert 225 to be retained in its desired position so that the final molded structure is more uniformly formed. Additionally, protruding portion 240 provides strengthening of that part of the handle where it is located when the article is used.

Alternatively, protruding portion can be provided along the perimeter of the insert 225 as well as that of rib 250. Such a configuration provides greater stability and hoop strength to the insert. Providing the protruding portion along the perimeter or outline of an insert is preferred when the insert has a round, oval or polygonal shape or a shape that includes a significant area compared to a linear or thinner decorative feature.

FIG. 9 shows a further feature of the invention wherein the elongated shaped insert 230 of the second molded structure further includes raised bumps 245 on the rear side of the fork 200. These raised bumps 245 are optional but when included are positioned along the back of insert 230 and provide an additional visual and tactile decorative feature for the fork 200. These bumps 245 are made of the same second shot material as bumps 235 and insert 230 and form the second molded structure. Preferably, they are arranged in the same positions as the bumps 235 that are provided on the top surface of the handle although this is not essential.

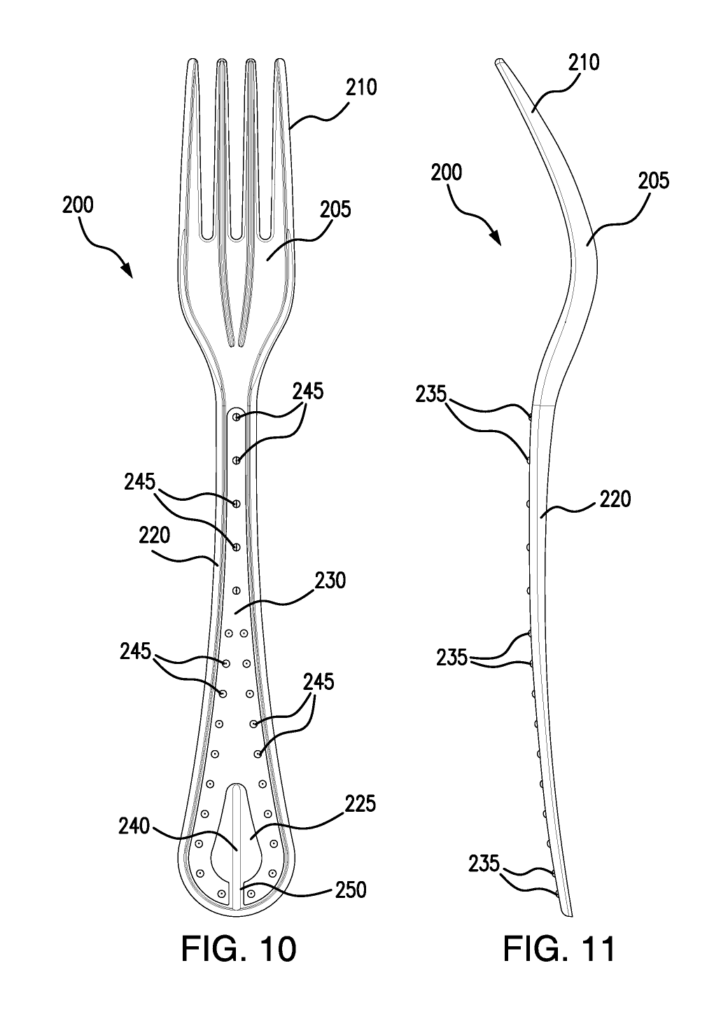

FIGS. 10 and 11 are additional views of the fork 200 of FIG. 7. FIG. 10 shows in further detail the protruding portion 240 and its association with sidewall 220 so that injected first material can flow into the insert 225 to or from sidewall 220. In a preferred embodiment, the first material is injected at the top of the teardrop shaped insert 225 on the back of the fork 200. This hides the injection port on the protruding portion 240. Alternatively, the injection point for the first material can be located at the end of the protruding portion where it joins the sidewall 220. In the side view of FIG. 11, protruding portion 240 and bumps 245 and are not visible because they are smaller than the sidewall 220.

While the bumps are shown as protruding out of the top and bottom surfaces of the handle, if they are arranged in the same position on the top and bottom of the handle, it would also be possible to make the bumps protrude on one surface and be recessed on the opposite surface to allow stacking of articles in a package for more compact shipping. For example, the bumps can protrude on the top surface of the handle and be recessed on the bottom surface of the handle to allow nesting of the protruding bumps into the recessed bumps for compact shipping.

A number of alternative embodiments are provided herein. Although the insert 225 is shown as having a teardrop shape within an elongated teardrop shaped sidewall 220, the shape of the insert 225 can be round, oval, polygonal or combinations thereof. The insert can also be designed as a letter, letters or words that include any combination of alphanumeric characters in block form or script subject only to the length and width of the handle that can accommodate such characters. The appropriate draft angles would be provided for such characters to facilitate their removal from the mold or the removal of the first mold from the characters and first molded structure after molding.

The outline of the sidewall 220 also may be of other shapes including round, oval, polygonal or combinations thereof. The sidewall 220 can mimic or correspond to the shape of the insert 225 or it can be entirely different depending upon the desired final appearance of the article. And although one insert 225 is shown, it is possible to provide multiple inserts of the same or different shapes. It is also possible to combine one or more linear bands as shown in FIG. 1 with rounded, teardrop or other shapes if desired.

It is envisioned that various features of the different embodiments can be combined to provide further varied decorative features in the final molded article. For optimum molding performance, however, the ribs or protruding portions disclosed herein are used to form a flow path for the first material as well as to provide strength to that part of the article where the ribs or protruding portions are located.

For larger size inserts, it may be desirable to provide additional or multiple protruded portions both for providing additional stability to the insert during injection of the second shot to resist lateral movement as well as to provide additional reinforcement to the strength and rigidity of the molded article.

In these type articles, it is common to provide angled, bent or substantially perpendicular sides or end portions to the periphery of the handle to provide further strength to the article. Also, the tines or other portions of the working end can be provided with additional structure or reinforcements to provide a stronger working end that is less subject to bending or breaking during use. A skilled artisan is generally aware of such features and how to include them in a molded structure such that they can be useful additions to the articles described herein.

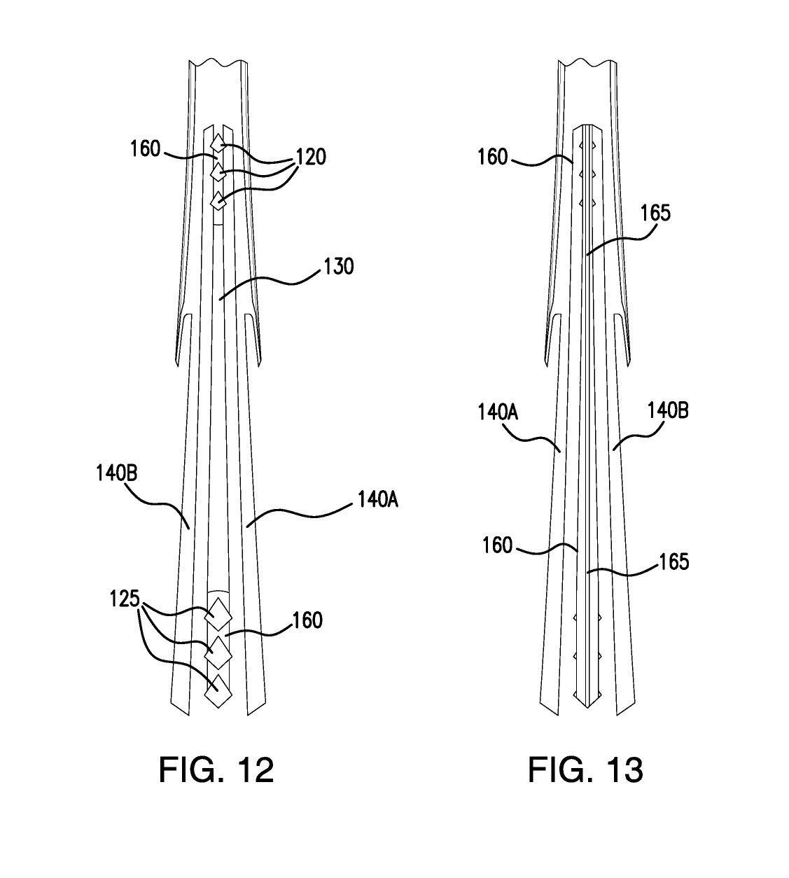

FIGS. 12 and 13 are expanded views of the first molded structure of FIG. 1 to show further details. As noted, diamonds 120, 125 and bands 130, 140A, 140B are all part of the first molded structure, along with the working end 105 and side upper handle portions 155A, 155B. The diamonds 120, 125 and band 130 are supported by rib 160 which supports those decorations and provides a flow channel for the first material to fill those decorations when the first molded structure is formed. Similarly, bands 140A, 140B are supported by protruded portions 170A, 170B which provide the same type of flow channel for those components.

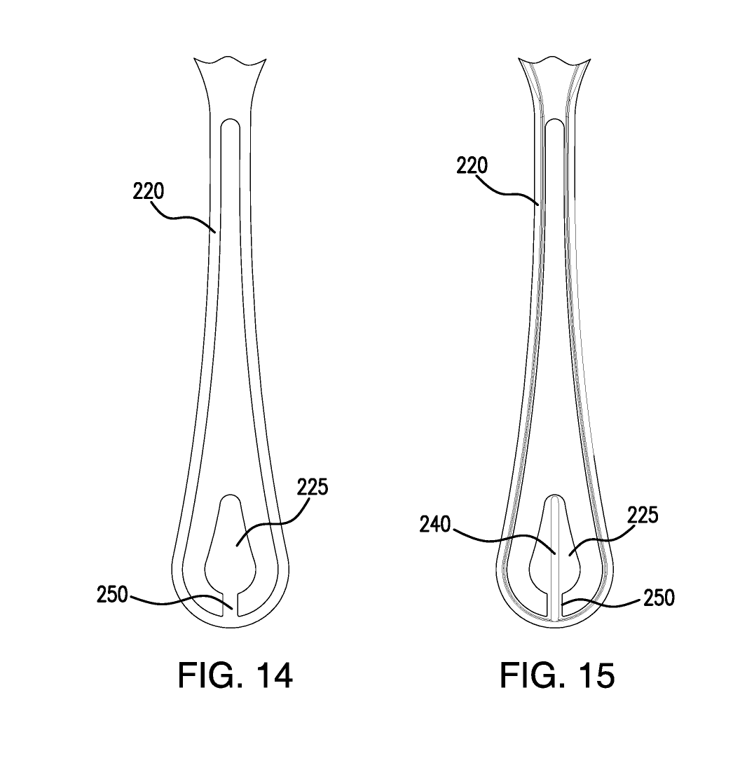

Similarly, FIGS. 14 and 15 are expanded views of the first molded structure of FIGS. 10 and 11 to show further details. As noted, in the front view, the teardrop shaped insert 225 is shown attached to the sidewall 220 by a rib 250 that is wider than protruding portion 240. Rib 250 and protruding portion 240 provide a flow channel for the first material to fill insert 225 when the first molded structure is formed. FIG. 15 shows that the protruding portion 240 is thinner than rib 250 and is used to hold the insert 225 in position when the second first material is injected to form the second molded structure around the insert 225 and within the sidewall 220.

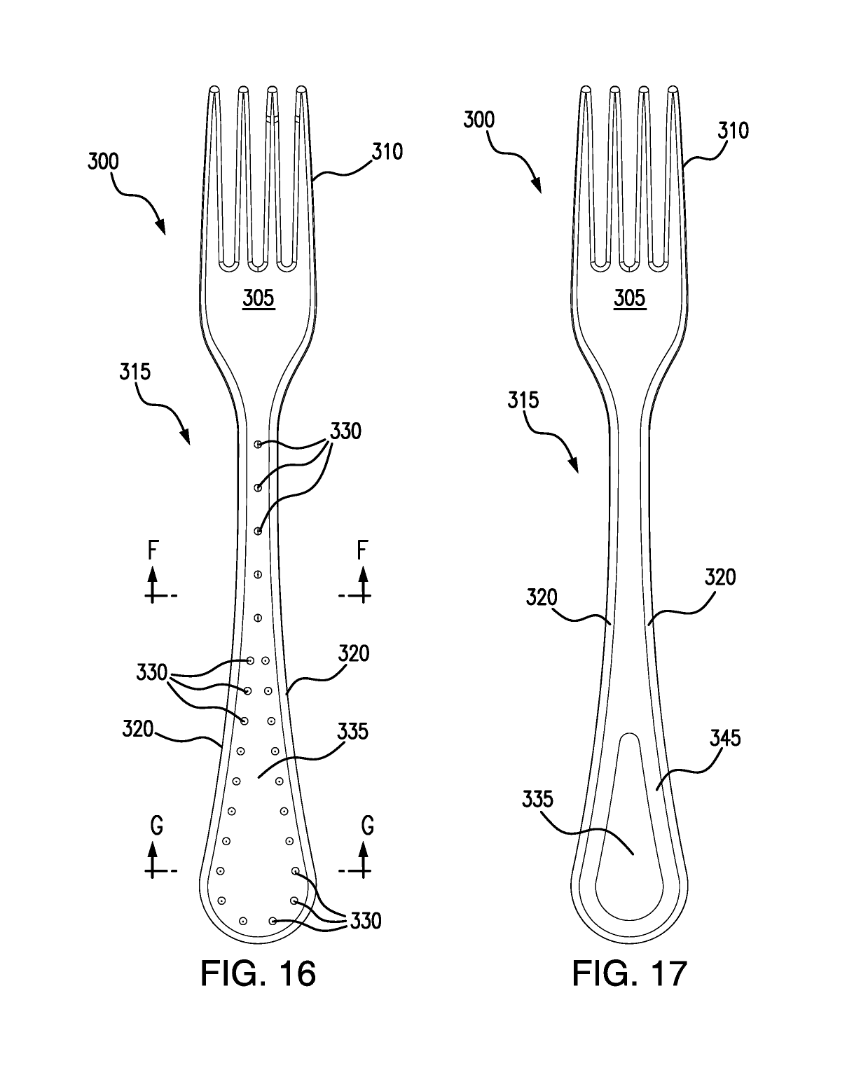

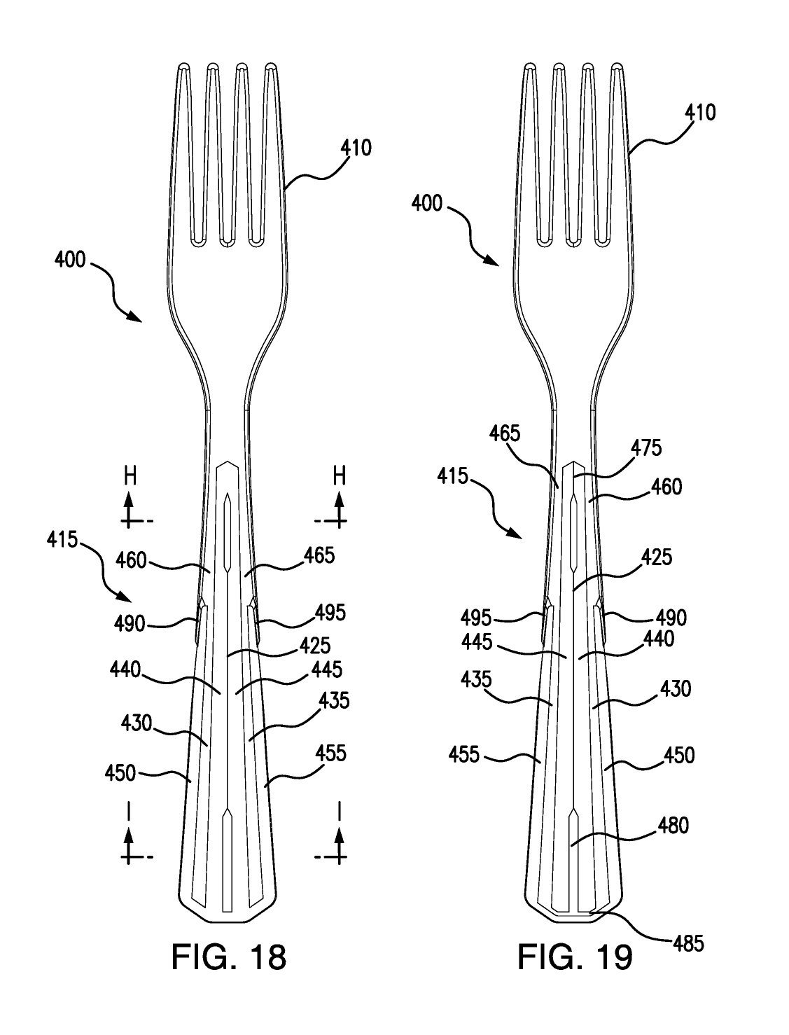

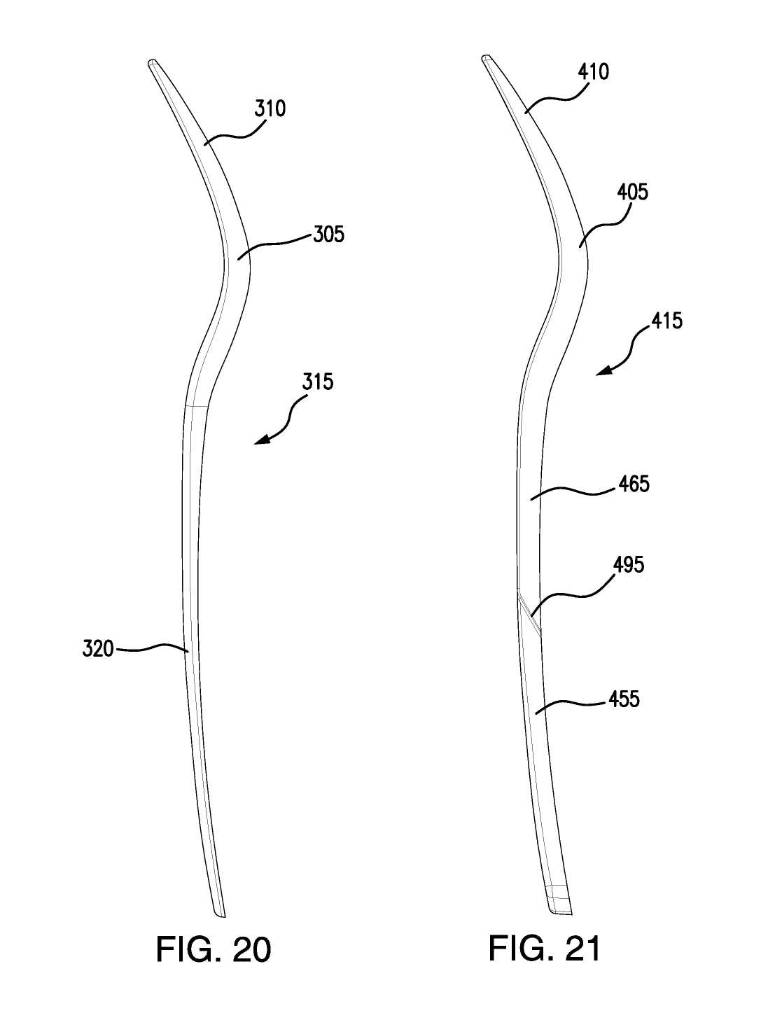

FIGS. 16, 17, 20, 22 and 23 illustrate a third embodiment of the invention. FIG. 16 illustrates an overmolded fork 300 according to the present invention that includes working end 305, tines 310 and a handle portion 315. The front or top of the fork includes a pattern that includes decorative features including a sidewall 320 and an elongated teardrop shaped insert 325 which extends over most of the top surface of the handle 315. The insert 325 surrounds a number of circular, flat dots 330 which are of a different color than the insert 325. The working end 305, tines 310, sidewall 320 and dots 330 are all included in the first molded structure and are made of the same first material. If desired, the dots can be provided as protruding or recessed bumps. The insert 325 is filled within the sidewall 320 and around the dots 330 and extends to the rear side of the fork 300 where a smaller teardrop shaped insert 335 is provided. The remainder of the back of the handle 315 is made of the first molded structure.

As best shown in FIG. 23, each dot 330 is connected to the sidewall 320 by a rib 340 which as in the other embodiments provides a flow channel for the first material to travel from the sidewall 320 to the dots 330. Thus, the first molded structure includes the dots 330 as discontinuous, floating islands in the second molded structure. The connecting rib 340 on the core side of first molded structure allows for these standing first shot islands to be visible through the second shot molded structure which surrounds them. Between the dots 330 on the rear side of the article, the sidewall 320 includes a base portion 345 which forms a border around the rear insert 335.

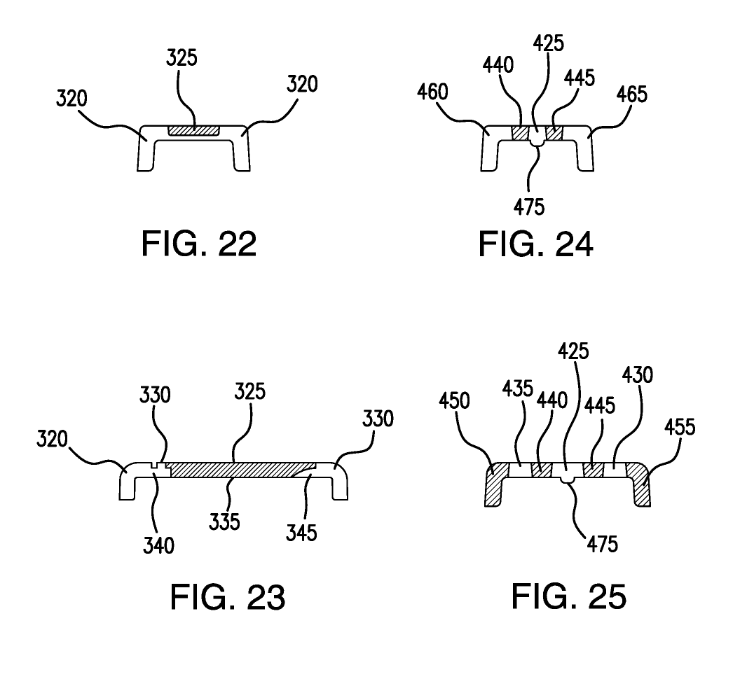

FIGS. 22 and 23 show that the sidewall 320 includes end portions which provide an overall U-shape or C-shape to the handle 315. This provides additional strength to the molded article to resist bending during use. For other articles, such as a cutlery knife, the handle can have the cross-sectional shape of an I-beam for additional strength. Alternatively, depending upon the first and second shot materials to be used, the sidewall can be a simple extension of the adjacent structures or features so that the top and bottom of the sidewall is flat and without bent or angled end portions. With this arrangement, the old portions of the handle that are not flat are the protrusion portions on the rear side. In some arrangements, these portions are not necessary and in that case the entire rear side of the handle 315 can be flat or arcuate with smooth front and rear surfaces.

Another feature of fork 300 is that the injection site for the first material is located in area that will later be covered by the second shot material and second molded structure. The injection site would be placed on one of the fill ribs that leading up to an island or dot 330. One particular location would be at one of the ribs for the dots 330 at the lowermost end of the handle 315. This allows for the injection mark for the first material to be completely hidden by the overmolded second shot.

FIGS. 18, 19, 21, 24 and 25 illustrate a fourth embodiment of the invention. FIG. 18 illustrates an overmolded fork 400 according to the present invention that includes working end 405, tines 410 and handle portion 415. The front or top of the fork includes a pattern that includes decorative features such as lines 425, 430 435 that are provided by the first molded structure. Line 425 has expanded upper and lower portions to provide further ornamentation to the handle 415. These lines along with the working end and tines represent the first molded structure. Contrasting colors are provided by the second molded structure which includes bands 440, 445, 450 and 455 all of which are joined together at the bottom of the handle 415. The first molded structure also include side portions 460 and 465 in the upper portion of the handle 415.

To facilitate the overmolding of this article, an angled shut off 490, 495 is provided so that the first molded structure easily accommodates the second material to form the second molded structure. This ensures good shut off from the second shot cavity onto the molded first shot structure and reduces skinning or flashing of the second shot material when overmolded onto the first molded structure. The angled shut off 490, 495 is positioned between an overlap of the second molded structure on the outside of the handle 415 onto the first molded structure which is on the inside of the handle.

The rear side of the article has a similar configuration to the front side. FIGS. 19, 24 and 25 illustrate this similar appearance with the main difference being that line 425 on the back side of the article includes protruding portion 475 which extends from the neck portion of the fork 400 to line 425 and then to the lower end of the handle 415 where the line 425 terminates at broadened area 480. As in the other embodiments, protruding portion provides a flow channel for the first material to travel to line 425, as well as providing stability to line 425 and the first molded structure during injection of the second shot to resist lateral movement as well as to provide additional strength and rigidity to the handle 415 of the molded article. Typically, the injection point would be at a lower portion of broadened area 480 so that the injection mark is relatively inconspicuous in the final molded article.

As best shown in FIG. 19, the ends of lines 425, 430, 435 are connected by a protruding portion 485 to provide further stability to those lines during injection of the second shot material. Alternatively, this connection can be by a rib that is visible on the rear side of the handle or it can be deigned to be covered by the second shot material so that it is not seen in in the final molded article. The latter arrangement is possible because protruding portion 475 provides the necessary lateral stability of the first molded structure, and the rib can be relatively thin while still providing the necessary flow path for the first shot material to fill lines 430, 435. As noted herein, the protruding portion can be an extended width of a band or segment that protrudes beyond the bottom surface of the article. When the decorative feature has a larger area, the protruding portion can be provided along the periphery of that feature.

As best shown in FIG. 24, the protruding portion 475 of line 425 extends below the rear bottom surface of the handle 415. As in the other embodiment, protruding portion acts as a stabilizing member to help provide lateral stability to line 425 by preventing lateral movement when the second material is introduced or injected into the mold to form the second molded structure. Protruding portion 475 also provides strengthening of that part of the handle where it is located when the article is used.

Lines 430, 435 as shown do not include a protruding portion but of course they can be included to provide further stability to the first molded structure as well as additional strength to the handle 415. FIGS. 24 and 25 show that the bands 450, 455 include optional end portions that are curved to provide an overall U-shape to the handle 415 which results in additional strength to resist bending during use of the molded article.

While the lines 425, 430, 435 are shown as continuous, a skilled artisan would immediately recognize that these lines can instead be provided in a discontinuous manner with shapes such as dots, diamonds, triangles, stars or other familiar or random shapes. Of course, protruding portion 475 would be continuous as it provides the flow path for the first material. And although it is preferred to have protruding portion held in the mold to resist lateral movement and provide stability to the first shot, in some embodiments, a rib can instead be used for this purpose with the rib embedded in the second molded structure so that it does not appear in the final molded product. As long as one of the surfaces includes a decoration that is provided by the first molded structure on the surface of the front or rear side of the handle, that decoration can be provided with a protruding portion so that it can provide stabilizing to the first shot when the second shot material is injected or introduced.

The molding procedure enables the process to be rapidly implemented for the low cost, high volume manufacture of the articles. Also, multiple mold cavities can be used to form large numbers of molded articles after the second shot to further enhance production.

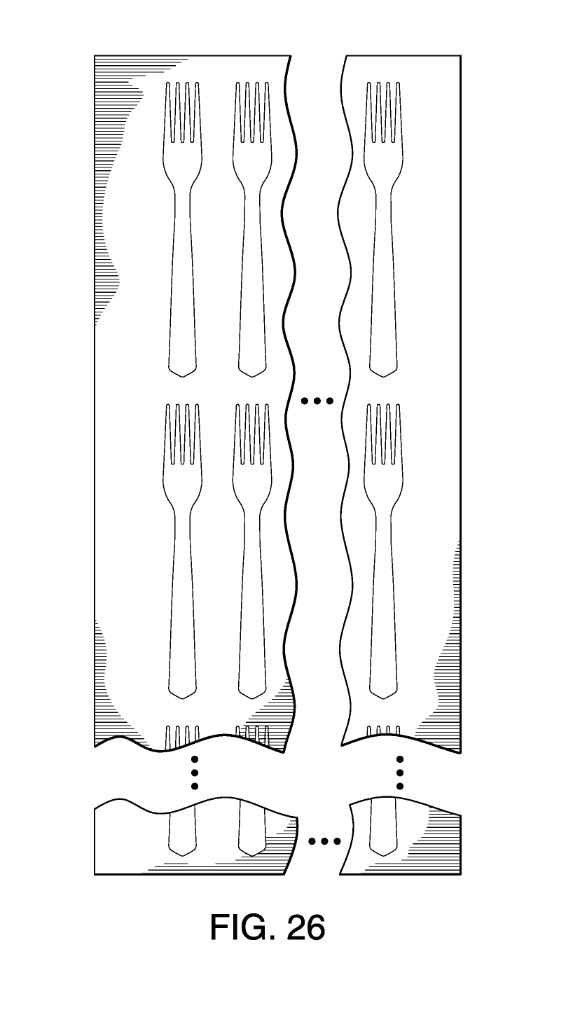

Regarding the number of articles to be manufactured, for disposable articles such as cutlery and the like, a mold having an array of 8×8 or 8×9 is preferably utilized so that the size of the mold does not become too large. Two side by side arrays of 8 by 9 are possible in each mold for a total of 144 articles to be molded at one time. Part of the mold surface that can be used for the forks disclosed herein as preferred embodiments of the invention is shown in FIG. 26. In that figure, the forks are shown placed in the mold with the back side of the first molded structure being initially formed with a first mold. Thereafter a second mold is placed over the first molded structure to form the second molded structure and final molded article which is removed from the mold after the second material sets. Alternatively, the article can be molded with the front side placed downwardly in the first mold and with the second mold placed over the first molded structure to form articles that would have the back side of the article facing outwards when the second mold is removed to remove the molded article. A skilled artisan can best determine the optimum arrangement for any particular article depending upon the decoration features that are being provided in the article and how to use protruding portions of such designs to stabilize the first shot.

FIG. 26 describes a mold for use with cutlery items of conventional hand held size. For the same size mold for other articles, a larger number of smaller articles can be provided, or a smaller number of larger articles can be provided. The only limiting factor is that there must be sufficient spacing between the rows and columns of the articles to accommodate positioning of the other portions of the first and second molds adjacent the mold portions that form and hold the first molded structure to allow the second molded structure to be formed.

In essence, it should be understood that the foregoing is solely considered as illustrative only of the principles of the invention. Furthermore, since numerous alterations and modifications and changes will readily be apparent and effected thereto by those having ordinary skill in the art, it is not desired to limit the invention to the exact constructions as demonstrated in this disclosure. For example, for certain molded articles, the first and second molded structures can be made separately and then joined together with adhesive or in a snap-locking manner. Accordingly all suitable modifications and equivalents may be resorted to falling within the scope of the invention so long as the inherent technical features and attributes are not lost.

In other modifications, the molded articles can have any other dimensions than the ones specifically described herein. Exemplary handles may have a flattened or slightly rounded cross section, but other shapes such as a substantially circular cross section, a substantially square or rectangular cross section, or combinations of the above can equally be used. Moreover, the islands may have a top surface comprising any suitable shape or topography.

Even though a fork is illustrated as an example, the invention similarly pertains to any other hand tool, which is encompassed by the scope of the present invention. As such, the invention similarly encompasses hand tools such as but not limited to knives, spoons, forks, salad forks, soup spoons, butter knives, steak knives, cocktail forks, serving forks and spoons, tongs, chop sticks, cake cutters, spatulas, ladles, food picks, kitchen utensils, and the like.

Unless defined otherwise, all technical and scientific terms used herein have same meaning as commonly understood by the person of ordinary skill in the art to which this invention belongs. As used herein and in the appended claims, the singular form “a”, “and”, and “the” include plural referents unless the context clearly dictates otherwise. All technical and scientific terms used herein have the same meaning. Thus the scope of the embodiments of the present invention should be determined by the appended claims and their legal equivalents rather than by the Figures.

What is claimed is:

1. A molded article comprising a first shot molded structure comprising a working end, a bottom end, at least one wall member extending from the working end to the bottom end of the structure and at least partially or fully outlining a handle for the article, at least one decorative feature that is configured and dimensioned to reside on a surface of a handle of the molded article with the decorative feature(s) spaced from and residing between the wall member(s), and a connecting element that facilitates a flow path for first material to fill the decorative feature(s); wherein the first shot molded structure is configured and dimensioned to receive a second material that at least partially resides on the handle surface surrounding the decorative feature(s).

2. The article of claim 1, wherein the decorative feature(s) have a continuous or discontinuous configuration, and wherein multiple decorative features are provided, with each residing at least partially on the handle surface and associated with a connecting element.

3. The article of claim 2, wherein multiple decorative features are associated with a single connecting element, and wherein some, most or all of the decorative features reside between or within the wall member(s).

4. The article of claim 1, wherein the wall member is a single wall member that is configured and dimensioned to outline the handle of the article as a sidewall, and wherein the connecting element is a rib that connects the first decorative feature(s) to the sidewall.

5. The article of claim 1, wherein the connecting element includes an elongated rib member that includes a protruding portion along at least a portion or all of its length or width, with the elongated rib member optionally being wider than the protruding portion.

6. The article of claim 1, wherein first and second wall members are provided as an outline of an upper portion of the handle and the wall members terminate in an angled side configuration which provides a shutoff for the second shot material.

7. The article of claim 1, wherein the first molded structure is configured with one or more holes or openings therethrough to allow the second material to form parts of the front and rear surfaces of the article.

8. The article of claim 1, which is configured to provide an injection port that adjacent a portion of the first molded structure which is to be overmolded by the second material so that the first injection port does not leave a visible mark on the final overmolded article.

9. The article of claim 1, wherein the molded structure has a core mold side and a cavity mold side wherein portions of the first molded structure that reside in the core mold have draft angles of less than 2 degrees and as low as 0.25 degrees, while portions of the first molded structure that are on the cavity mold side have draft angles that are greater than 2 degrees and as much as 5 degrees or more.

10. The article of claim 1, further comprising a second shot molded structure molded from the second material and including surface portions that form top and bottom surfaces of the handle and that surround or encompass but do not cover the decorative feature(s) of the first molded structure.

11. The article of claim 10, wherein the wall member is a single sidewall that is configured and dimensioned to outline the handle of the article and the sidewall fully surrounds or encompasses the second shot molded structure.

12. The article of claim 11, wherein the connecting element includes an elongated rib member that includes a protrusion portion that prevents lateral movement of the first molded structure when the second material is introduced onto the first molded structure.

13. The article of claim 10, wherein the decorative feature(s) of the first molded structure includes one or more of:
a teardrop shaped element that is present on a front surface of the handle and the connecting element forms a further decorative feature on a rear surface of the handle; or
one or more cylindrical elements which extend to a front surface of the handle;
one or more linear elements which are continuous or discontinuous and which reside on a front surface of the handle, a rear surface of the handle, or on both surfaces with the linear element(s) associated with a single connecting element or each linear element connected to a separate connecting element; or
one or more shapes of a polygon, circle, oval, alphanumeric character or combination thereof; or
one or more protruding members that protrude from the handle surface at, along or about its periphery.

14. The article of claim 10, wherein the first and second molded structures are made of a plastic resin, an elastomer, or a polyurethane material, and the first material contrasts with the second material by color, transparency, translucency, brightness, texture, hardness or another physical property.

15. The article of claim 10, in the form of cutlery wherein the working end is a fork, knife or spoon.

16. A molded article comprising a first shot molded structure comprising a working end, a bottom end, at least one wall member extending from the working end to the bottom end of the structure and at least partially or fully outlining a handle for the article; wherein the molded structure has a core mold side and a cavity mold side wherein portions of the first molded structure that reside in the core mold have draft angles of less than 2 degrees to as low as 0.25 degrees, while portions of the first molded structure that are on the cavity mold side have draft angles that are greater than 2 degrees and as much as 5 degrees or more; and further wherein the first shot molded structure is configured and dimensioned to receive a second material that at least partially resides on the handle surface.

17. The article of claim 16, wherein the first shot molded structure further comprises a plurality of elongated members, ribs or bands extending away from the working end.

18. The article of claim 17, wherein the one or more of the elongated members, ribs or bands includes a protrusion portion that prevents lateral movement of the first molded structure when the second material is introduced onto the first molded structure.

19. The article of claim 16, wherein the wall member is a single wall member that is configured and dimensioned to outline the handle of the article as a sidewall.

20. The article of claim 16, further comprising a second shot molded structure molded from the second material and including surface portions that form top and bottom surfaces of the handle and that surround or encompass but do not cover the decorative feature(s) of the first molded structure.

21. The article of claim 20, wherein the first shot molded structure further comprises a plurality of elongated members, ribs or bands extending away from the working end and the second shot molded structure includes a plurality of elongated members, ribs or bands that are located adjacent the elongated members, ribs or bands of the first shot molded structure to form the handle of the article.

22. The article of claim 20, wherein the wall member of the first shot molded structure is a single wall member that is configured and dimensioned to outline the handle of the article as a sidewall and wherein all of the second shot molded structure resides within the wall member.

23. The article of claim 20, wherein the first and second molded structures are made of a plastic resin, an elastomer, or a polyurethane material, and the first material contrasts with the second material by color, transparency, translucency, brightness, texture, hardness or another physical property.

24. The article of claim 20 in the form of cutlery wherein the working end is a fork, knife or spoon.
